(19) United States
(12) Patent Application Publication
(10) Pub. No.: US 2018/0272978 A1
(43) Pub. Date: Sep. 27, 2018

(54) APPARATUS AND METHOD FOR OCCUPANT SENSING

(71) Applicant: GM GLOBAL TECHNOLOGY OPERATIONS LLC, Detroit, MI (US)

(72) Inventors: Eric Raphael, Birmingham (US); Ariel Lipson, Tel Aviv (IS)

(73) Assignee: GM GLOBAL TECHNOLOGY OPERATIONS LLC, Detroit, MI (US)

(21) Appl. No.: 15/470,204

(22) Filed: Mar. 27, 2017

(51) Int. Cl. B60R 21/015; G06K 9/20; G01S 17/89; G06K 9/00

(52) U.S. Cl. CPC B60R 21/01534; B60R 21/01512; B60R 2001/1223; G01S 17/89; G06K 9/00221; G06K 9/209

(57) ABSTRACT

A method and apparatus for imaging occupants are provided. The apparatus includes a reflective surface; an imaging sensor configured to capture an image of the reflective surface; and a controller configured to process the captured image and control to perform a function based on the captured image. The method and apparatus may be implemented in a vehicle to detect occupant movement and behavior.

### INTRODUCTION

Apparatuses and methods consistent with exemplary embodiments relate to occupant sensing systems. More particularly, apparatuses and methods consistent with exemplary embodiments relate to vehicle based occupant sensing systems.

### SUMMARY

One or more exemplary embodiments provide a method and an apparatus that sense an occupant of vehicle. More particularly, one or more exemplary embodiments provide a method and an apparatus that sense occupant movement, position, state and/or behavior by imaging a reflective surface.

According to an aspect of an exemplary embodiment, an apparatus that senses an occupant is provided. The apparatus includes: a reflective surface; an imaging sensor configured to capture an image of the reflective surface; and a controller configured to process the captured image and control to perform a function based on the captured image.

The reflective surface may be a glass surface. Moreover, the reflective surface may be at least one from among a windshield, an instrument cluster lens, A-pillar trim, an instrument panel, and an airbag cover.

The imaging sensor may include an infrared sensor that captures an infrared image of the reflective surface.

The apparatus may include an illumination device configured to illuminate an occupant of the vehicle.

The controller may control the illumination device to illuminate the occupant of the vehicle based on the image captured by the imaging sensor.

The illumination device may include an infrared illuminator.

The illumination device may be mounted in a steering column, a dashboard, or a headliner.

The reflective surface may include a coating configured to reflect infrared light.

Moreover, the reflective surface may be transmissive to visible light.

The occupant sensing apparatus may be mounted in a vehicle.

The imaging sensor may be mounted in a steering column, a dashboard, a pillar, or a headliner.

The controller may be configured to analyze the image to determine at least one from among a gesture of an occupant, a direction of an occupant gaze, facial tracking of an occupant, and a motion of an occupant.

According to an aspect of an exemplary embodiment, a method for sensing an occupant of vehicle is provided. The method includes illuminating a subject, capturing an image of the subject by imaging a reflective surface, and performing a function based on the captured image.

The illuminating the subject may include adjusting illumination of the subject based on the captured image.

The performing the function may include analyzing the captured image to determine at least one from among a gesture of a subject, a direction of a subject's gaze, facial tracking of a subject, and a motion of a subject.

The illuminating the subject may include illuminating the subject with infrared light.

The reflective surface may include a coating configured to reflect infrared light.

The reflective surface may include at least one from among a windshield, an instrument cluster lens, an A-pillar trim, an instrument panel, and an airbag cover.

The capturing the image may include capturing an infrared image of reflective surface.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that senses an occupant according to an exemplary embodiment;

FIG. 2 shows a flowchart for a method of sensing a subject according to an exemplary embodiment;

FIG. 3 shows diagram of an apparatus that senses an occupant of a vehicle according to an aspect of an exemplary embodiment; and

FIG. 4 shows examples of images captured by the apparatus senses an occupant of as vehicle as compared to direct captured images, according to an aspect of an exemplary embodiment.

### DETAILED DESCRIPTION OF EXEMPLARY EMBODIMENTS

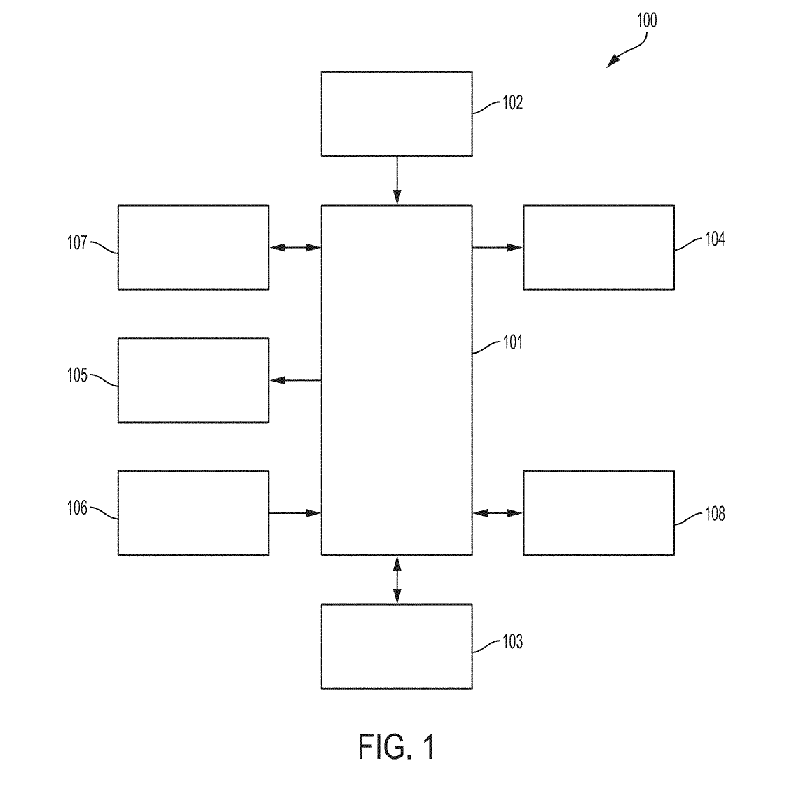

An apparatus and method that sense an occupant of a vehicle will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles may include a plurality of sensors configured to detect events and collect information necessary to perform vehicle functions. Some of the sensors are designed to collect information on occupants, for example, to detect the presence of occupants, the motion of occupants, and the position of occupants. One such sensor is an imaging sensor or camera that faces an occupant or operator of the vehicle. Image data from the camera may be analyzed to detect facial expressions, movements, gestures, position, and/or presence of an occupant or operator of vehicle. However, placing the camera in position to capture an image of an occupant presents difficulties because of limited space and the presence of obstructions to the view of the camera.

One way to address the aforementioned issues would be to capture an image of a reflection of a subject such as an occupant or operator of a vehicle. Since there are many surfaces from which a reflection can be captured, the number of locations for placing an imaging sensor, such as a camera, to capture images of the reflections increases. Thus, there is greater flexibility in capturing images of an occupant and performing functions based on the images or information derived from the images.

FIG. 1 shows a block diagram of an apparatus that senses an occupant 100 according to an exemplary embodiment. As shown in FIG. 1, the apparatus that senses an occupant 100, according to an exemplary embodiment, includes a controller 101, a power supply 102, a storage 103, an output 104, an illumination device 105, a user input 106, an imaging sensor 107, and a communication device 108. However, the apparatus that senses an occupant 100 is not limited to the aforementioned configuration and may be configured to include additional elements and/or omit one or more of the aforementioned elements. The apparatus that senses an occupant 100 may be implemented as part of a vehicle, as a standalone component, as a hybrid between an on vehicle and off vehicle device, or in another computing device.

The controller 101 controls the overall operation and function of the apparatus that senses an occupant 100. The controller 101 may control one or more from among a storage 103, an output 104, an illumination device 105, a user input 106, and a communication device 108 of the apparatus that senses an occupant 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 may be configured to send and/or receive information from one or more of the storage 103, the output 104, the illumination device 105, the user input 106, the imaging sensor 107, and the communication device 108 of the apparatus that senses an occupant 100. The information may be sent and received via a bus or network, or may be directly read or written to/from one or more of the storage 103, the output 104, the user input 106, and the communication device 108 of the apparatus that senses an occupant 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the illumination device 105, the user input 106, the imaging sensor 107, and the communication device 108, of the apparatus that senses an occupant 100. The power supply 102 may include one or more from among a battery, an outlet, a capacitor, a solar energy cell, a generator, a wind energy device, an alternator, etc.

The storage 103 is configured for storing information and retrieving information used by the apparatus that senses an occupant 100. The storage 103 may be controlled by the controller 101 to store and retrieve information received from the illumination device 105. The information may include information and/or one or more images taken by the imaging sensor 107. In addition, the storage 103 may also include the computer instructions configured to be executed by a processor to perform the functions of the apparatus that senses an occupant 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that senses an occupant 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an instrument panel display, a center stack display, a rear view mirror display, a side view mirror display, an indicator light, etc.

According to one example, the output 104 may be one or more from among a center stack display, an instrument panel display or a heads up display. The output 104 may be configured to output one or more messages or notifications based on an analysis of images from the imaging sensor 107. The notifications may be in one or more forms such as an audible notification, a light notification, and a display notification.

The user input 106 is configured to provide information and commands to the apparatus that senses an occupant 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104.

The illumination device 105 may be one or more from a light, an infrared illuminator, etc. The illumination device 105 may located in a steering column, a dashboard, a pillar, or a headliner. In addition, the illumination device 105 may be configured to illuminate a subject or an occupant of the vehicle. In particular, the illumination device 105 may adjust an illumination level based on the image captured by imaging sensor 107.

The imaging sensor 107 may be one or more from a camera, an infrared camera, or a night vision camera. The imaging sensor 107 may be located in a steering column, a dashboard, a pillar, a headliner, etc. The imaging sensor 107 may be configured to capture an infrared image or other image of the reflective surface.

The communication device 108 may be used by apparatus that senses an occupant 100 to communicate with various types of external apparatuses according to various communication methods. The communication device 108 may be used to send/receive image information to/from the imaging device 107. The illumination device 105 and/or imaging sensor 107 may send/receive commands and/or information to/from the controller via communication device 108. In addition, the communication device 108 may be send image information to the output 104 to be output on a display of the apparatus that senses an occupant 100.

According to an example, the communication device may be used to provide information from the apparatus that senses an occupant 100 to other devices. The information may include a state of an occupant, a location of an occupant, a direction of an eye gaze of an occupant, whether an occupant is drowsy or not, a position of an occupant, a movement of an occupant, a position of a head of an occupant, or a position of an arm, a leg, a foot, a hand, a finger or other extremity of an occupant.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an example, the controller 101 of the apparatus that senses an occupant 100 may be configured to control the imaging sensor to capture an image of the reflective surface, process the captured image and control to perform a function based on the captured image

The controller 101 of the apparatus that senses an occupant 100 may be configured to control the illumination device to illuminate the occupant of the vehicle based on the image captured by the imaging sensor. In addition, the controller 101 of the apparatus that senses an occupant 100 may be configured to analyze the image to determine at least one from among a gesture of an occupant, a direction of an occupant gaze, facial tracking of an occupant, and a motion of an occupant.

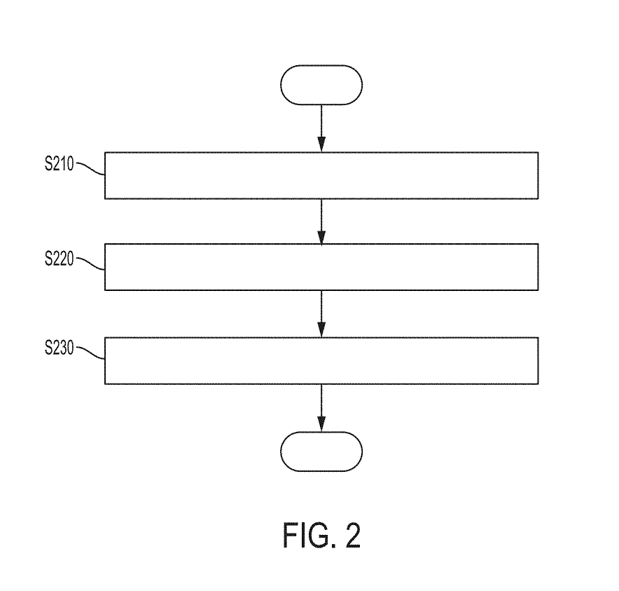

FIG. 2 shows a flowchart for a method of sensing a subject according to an exemplary embodiment. The method of FIG. 2 may be performed by the apparatus that senses an occupant 100 or may be encoded into a computer readable medium as instructions that are executable by a computer to perform the method.

Referring to FIG. 2, a subject may be illuminated in operation 210. For example, an infrared illumination device may beam infrared light at the subject.

In operation S220, an image of the reflection of the subject is captured by an imaging sensor. For example, an infrared imaging sensor may capture an image of the reflection of the subject form the windshield or other surface of the vehicle.

In operation S230, the controller may control to perform a function based on the captured image. For example, the controller may adjust the light beamed by the illumination device at the subject. In another example, the controller may control to perform a function of a vehicle based on an analysis of the captured image. The analysis of the captured image may determine one or more of a gesture of an occupant, a direction of an occupant gaze, facial tracking of an occupant, or a motion of an occupant.

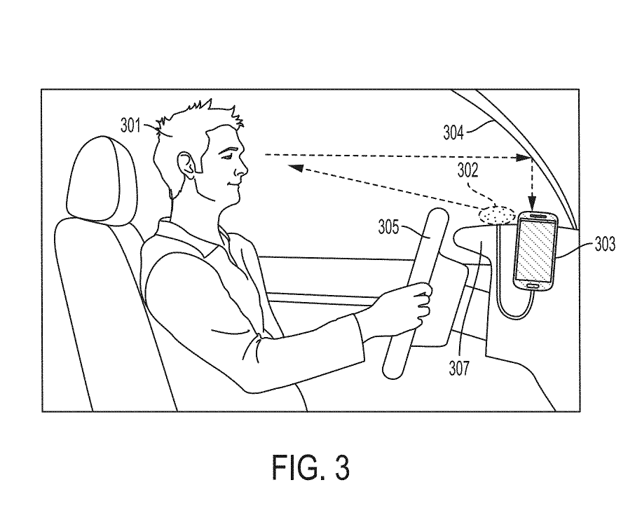

FIG. 3 shows diagram of an apparatus that senses an occupant of a vehicle according to an aspect of an exemplary embodiment. The illustrations of FIG. 3 illustrates an example set up of the apparatus that senses an occupant.

Referring to FIG. 3, an operator 301 of a vehicle is behind the steering wheel 305 of the vehicle. The windshield 304 reflects an image of the operator 301. The windshield 304 is on example of a reflective surface. However, the reflective surface may be one or more from among a windshield, an instrument cluster lens, A-pillar trim, an instrument panel, a glass surface, a plastic surface, and an airbag cover. In addition, the reflective surface may have a coating configured to reflect infrared light. For example, the reflective surface may be or any surface onto which a reflective coating that reflects an infrared or visible light spectrum can be applied.

An illumination device 302 may be placed on the dashboard 307 or other suitable location and may illuminate the operator 301 of the vehicle. For example, the illumination device 302 may beam infrared light at the operator 301. The beamed light enhances the reflection in the windshield 304 and imaging sensor 303, which is also present in dashboard 307, may capture an image of the reflection from the windshield 304. The image captured by the imaging sensor 303 may be captured through infrared imaging. A controller (not shown) may control the operation of the imaging sensor 303 and the illumination device 302.

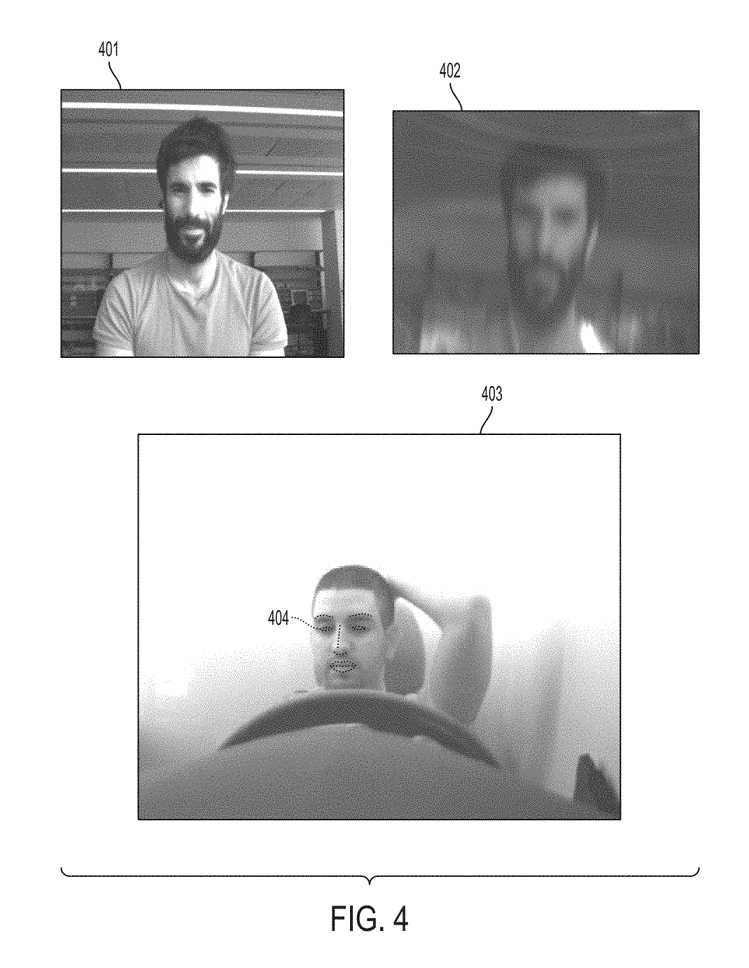

FIG. 4 shows examples of images captured by the apparatus senses an occupant of as vehicle as compared to direct captured images, according to an aspect of an exemplary embodiment. Referring to FIG. 4, a first image 401 shows an image of a subject that is captured by direct imaging. A second image 402 is an image of subject captured by imaging the reflection of the subject. As can be seen, the direct imaging image 401 is much clearer than the image of the reflection 402.

A third image 403 captured by an exemplary embodiment is clearer than the second image 402 and almost as clear and detailed as the direct imaging image 401. The clarity of this image enables the use of reflectance imaging to produce an image that may be used to perform functions based on an analysis of the image or the actions of the subject in the image.

According to an example shown in FIG. 4, facial features 404, among other features, may be detected in the third image and used to determine facial expressions of a subject and/or gaze of a subject. The analysis of the third image 403 or the facial expressions 404 may be used to perform functions based on the third image 403.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. An apparatus that senses an occupant, the apparatus comprising:
a reflective surface;
an imaging sensor configured to capture an image of the reflective surface; and
a controller configured to process the captured image and control to perform a function based on the captured image.

2. The apparatus of claim 1, wherein the reflective surface comprises a glass surface.

3. The apparatus of claim 1, wherein the reflective surface comprises at least one from among a windshield, an instrument cluster lens, A-pillar trim, an instrument panel, and an airbag cover.

4. The apparatus of claim 1, wherein the imaging sensor comprises an infrared sensor that captures an infrared image of the reflective surface.

5. The apparatus of claim 1, further comprising an illumination device configured to illuminate an occupant of the vehicle.

6. The apparatus of claim 5, wherein the controller controls the illumination device to illuminate the occupant of the vehicle based on the image captured by the imaging sensor.

7. The apparatus of claim 6, wherein the illumination device comprises an infrared illuminator.

8. The apparatus of claim 7, wherein the illumination device is mounted in a steering column, a dashboard, or a headliner.

9. The apparatus of claim 1, wherein the reflective surface comprises a coating configured to reflect infrared light.

10. The apparatus of claim 1, wherein the reflective surface is transmissive to visible light.

11. The apparatus of claim 10, wherein the occupant sensing apparatus is mounted in a vehicle.

12. The apparatus of claim 11, wherein the imaging sensor is mounted in a steering column, a dashboard, a pillar, or a headliner.

13. The apparatus of claim 1, wherein the controller is configured to analyze the image to determine at least one from among a gesture of an occupant, a direction of an occupant gaze, facial tracking of an occupant, and a motion of an occupant.

14. A method for sensing an occupant of vehicle, the method comprising:
illuminating a subject;
capturing an image of the subject by imaging a reflective surface; and
performing a function based on the captured image.

15. The method of claim 14, wherein the illuminating the subject further comprises adjusting illumination of the subject based on the captured image.

16. The method of claim 14, wherein the performing the function comprises analyzing the captured image to determine at least one from among a gesture of a subject, a direction of a subject's gaze, facial tracking of a subject, and a motion of a subject.

17. The method of claim 14, wherein the illuminating the subject comprises illuminating the subject with infrared light.

18. The method of claim 14, wherein the reflective surface comprises a coating configured to reflect infrared light.

19. The method of claim 18, wherein the reflective surface comprises at least one from among a windshield, an instrument cluster lens, an A-pillar trim, an instrument panel, and an airbag cover.

20. The method of claim 14, wherein the capturing the image comprises capturing an infrared image of reflective surface.
